(19) United States
(12) Patent Application Publication
(10) Pub. No.: US 2025/0203127 A1
(43) Pub. Date: Jun. 19, 2025

(54) INTERACTION METHOD AND APPARATUS, ELECTRONIC DEVICE, MEDIUM AND PROGRAM PRODUCT

(71) Applicant: Beijing Zitiao Network Technology Co., Ltd., Beijing (CN)

(72) Inventor: Yan WANG, Beijing (CN)

(21) Appl. No.: 18/846,232

(22) PCT Filed: Feb. 17, 2023
(86) PCT No.: PCT/CN2023/076807

§ 371 Date: Sep. 11, 2024

(30) Foreign Application Priority Data
Mar. 11, 2022 (CN) 202210239352.7

(51) Int. Cl. H04N 21/2187; G06F 3/0488; H04N 21/431; H04N 21/472

(52) U.S. Cl. CPC H04N 21/2187; G06F 3/0488; H04N 21/4312; H04N 21/47205

(57) ABSTRACT

The embodiments of the present disclosure relate to an interaction method and apparatus, an electronic device, a medium and a program product. The method includes: in response to a trigger operation in respect of an identifier of a target resource on a resource panel, displaying the target resource on a live streaming page; in response to an input operation in respect of the target resource, acquiring display information corresponding to the target resource; a first client sending the display information to a server, and sending the display information to a second client by means of the server, so that the target resource is displayed on the live streaming page at the second client according to the display information.

### CROSS-REFERENCE TO RELATED APPLICATIONS

The present disclosure is a U.S. National Stage Application under 35 U.S.C. § 371 of International Patent Application No. PCT/CN2023/076807, filed on Feb. 17, 2023, which is based on and claims the priority to the Chinese application No. 202210239352.7 entitled “INTERACTION METHOD AND APPARATUS ON A LIVE STREAMING CHANNEL, ELECTRONIC DEVICE, MEDIUM AND PROGRAM PRODUCT” and filed on Mar. 11, 2022, the disclosures of which are incorporated by reference in their entireties.

### TECHNICAL FIELD

Embodiments of the present disclosure relate to the field of computer technology, and in particular, to an interaction method, an interaction apparatus, and a non-transitory computer-readable storage medium, electronic device, and computer program product for implementing the interaction method.

### BACKGROUND

With the rapid development of Internet information technology, live business also develops, and more and more live platforms are generated through which users can view live content of an anchor on a live streaming channel or in a live streaming room, and in response to the users viewing a live video on the live streaming channel, the users can present a gift to the anchor to achieve interaction with the anchor.

### SUMMARY

In a first aspect, an embodiment of the present disclosure provides an interaction method, comprising:
in response to a trigger operation for an identifier of a target resource on a resource panel, displaying the target resource on a live streaming page; in response to an input operation for the target resource, acquiring display information corresponding to the target resource; and
sending the display information to a server to send the display information to a second client through the server, so that the target resource is displayed on the live streaming page at the second client according to the display information.

In some embodiments, the input operation comprises a touch operation; and the in response to an input operation for the target resource, acquiring display information corresponding to the target resource, comprises:
in response to the touch operation for the target resource, acquiring movement information of one or more touch points corresponding to the touch operation; and
acquiring the display information corresponding to the target resource based on the movement information of the one or more touch points.

In some embodiments, in response to a type of the touch operation being single-touch, the movement information of the one or more touch points comprises movement information of a single touch point, and the acquiring the display information corresponding to the target resource based on the movement information of the one or more touch points, comprises:
acquiring information of a display path corresponding to the target resource according to the movement information of the single touch point, the display information comprising the information of the display path.

In some embodiments, in response to a type of the touch operation being multi-touch, the movement information of the one or more touch points comprises movement information corresponding to each of a plurality of touch points; and the acquiring the display information corresponding to the target resource based on the movement information of the one or more touch points, comprises:
acquiring information of a display size and/or a display angle corresponding to the target resource according to the movement information corresponding to each of the plurality of touch points, the display information comprising the information of the display size and/or the display angle.

In some embodiments, in response to the display information comprising the information of the display size, the acquiring information of a display size and/or a display angle corresponding to the target resource according to the movement information corresponding to each of the plurality of touch points, comprises:
determining distances between the plurality of touch points according to the movement information corresponding to each of the plurality of touch points; and
determining the information of the display size corresponding to the target resource according to the distances between the plurality of touch points.

In some embodiments, in response to the display information comprising the information of the display angle, the acquiring information of a display size and/or a display angle corresponding to the target resource according to the movement information corresponding to each of the plurality of touch points, comprises:
determining rotation angles of connection lines between the plurality of touch points according to the movement information corresponding to each of the plurality of touch points; and
acquiring the information of the display angle corresponding to the target resource according to the rotation angles of the connection lines between the plurality of touch points.

In some embodiments, the in response to an input operation for the target resource, acquiring display information corresponding to the target resource, comprises:
in response to an input operation for a target display mode in a display setting panel corresponding to the target resource, acquiring display information corresponding to the target display mode as the display information corresponding to the target resource.

In some embodiments, the target display mode comprises: one or more of a display path, a display size, or a display angle.

In some embodiments, the method further comprises:
in response to the target resource being displayed on the live streaming page, starting timekeeping; and
in response to a timekeeping duration being greater than a preset duration, controlling the display of the target resource from the live streaming page to end.

In a second aspect, an embodiment of the present disclosure provides an interaction apparatus, applied to a first client, comprising:
a display module configured to, in response to a trigger operation for an identifier of a target resource on a resource panel, display the target resource on a live streaming page;
a processing module configured to, in response to an input operation for the target resource, acquire display information corresponding to the target resource; and
a communication module configured to, send the display information to a server to send the display information to a second client through the server, so that the target resource is displayed on the live streaming page at the second client according to the display information.

In a third aspect, an embodiment of the present disclosure provides a non-transitory computer-readable storage medium having thereon stored a computer program which, when executed by a processor, implements the interaction method according to the first aspect and any of the first aspect.

In a fourth aspect, an embodiment of the present disclosure provides an electronic device, comprising: a memory and a processor, the memory being configured to store computer program instructions, and the processor being configured to execute the computer program instructions to implement the interaction method according to the first aspect and any of the first aspect.

In a fifth aspect, the present disclosure provides a computer program product which, when executed by an electronic device, causes the electronic device to implement the interaction method according to the first aspect or any of the first aspect.

### BRIEF DESCRIPTION OF THE DRAWINGS

The accompanying drawings here, which are incorporated in and constitute a part of this specification, illustrate embodiments consistent with the present disclosure and, together with the description, serve to explain the principles of the present disclosure.

In order to more clearly illustrate technical solutions in the embodiments of the present disclosure or the prior art, the drawings that need to be used in the description of the embodiments or the prior art will be briefly described below, and it is obvious that for one of ordinary skill in the art, other drawings can be obtained according to these drawings without paying inventive labor.

FIG. 1 is a schematic flow diagram of an interaction method according to some embodiments of the present disclosure;

FIG. 2 is a schematic flow diagram of an interaction method according to other embodiments of the present disclosure;

FIG. 3a is a schematic diagram of determining a display path of a target resource based on movement information of a single touch point according to some embodiments of the present disclosure;

FIG. 3b is a schematic diagram of determining a display size and display angle of a target resource based on movement information of a plurality of touch points according to some embodiments of the present disclosure;

FIG. 4 is a schematic flow diagram of an interaction method according to other embodiments of the present disclosure;

FIGS. 5a-5f are diagrams of human-computer interaction interfaces according to some embodiments of the present disclosure;

FIG. 6 is a schematic structural diagram of an interaction apparatus according to some embodiments of the present disclosure;

FIG. 7 is a schematic structural diagram of an electronic device according to some embodiments of the present disclosure.

### DETAILED DESCRIPTION

In order that the above objectives, features and advantages of the present disclosure may be more clearly understood, solutions of the present disclosure will be further described below. It should be noted that, without conflict, the embodiments of the present disclosure and features in the embodiments may be combined with each other.

In the following description, numerous specific details are set forth in order to provide a thorough understanding of the present disclosure, but the present disclosure may also be implemented in other ways than those described herein; and it is obvious that the embodiments in the description are only a part of the embodiments of the present disclosure, rather than all of them.

It should be understood that, hereinafter, “at least one” refers to one or more, “a plurality” refers to two or more. “and/or” is used for describing an association relationship between associated objects, and indicates that there may be three relationships, for example, “A and/or B” may represent three cases: the presence of A alone, the presence of B alone, and the presence of A and B simultaneously, wherein A and B may be singular or plural. A character “/” generally indicates that preceding and succeeding objects associated are in an “or” relationship. “At least one of the following items” or its similar expression refers to any combination of these items, including any combination of the singular or plural items. For example, at least one of a, b, or c, may represent: a, b, c, “a and b”, “a and c”, “b and c”, or “a and b and c”, wherein a, b and c may be single or plural.

At present, there is a relatively single resource presenting mode in a live process, which is difficult to meet growing requirements of users for live interactivity, affecting the user experience.

In order to solve the technical problem, the embodiments of the present disclosure provide an interaction method, an interaction apparatus, and a non-transitory computer-readable storage medium, electronic device and computer program product for implementing the interaction method. The interaction method in the present disclosure is also called the interaction method on a live streaming channel. The interaction apparatus in the present disclosure is also called the interaction apparatus on a live streaming channel.

The embodiments of the present disclosure provide an interaction method and apparatus, an electronic device, a medium and a program product, wherein the method comprises: in response to a trigger operation for an identifier of a target resource on a resource panel, displaying the target resource on a live streaming page; in response to an input operation for the target resource, acquiring display information corresponding to the target resource; and the first client sending the display information to a server to send the display information to a second client through the server, so that the target resource is displayed on the live streaming page at the second client according to the display information. With the method, after a user presents a target resource on a live streaming channel, a display mode of the target resource can be changed by means of an input operation, so that the user sending the target resource can participate in controlling the display mode of the target resource, and other users (such as an anchor or other users) on the live streaming channel can also synchronously view that the target resource is displayed in the changed display mode, enriching the resource interaction mode on the live streaming channel, helping to improve the interactivity among different users on the live streaming channel, and enhancing the user experience. For example, a resource comprises a gift, and an identifier of a resource comprises icon, text or thumbnail. For example, the live streaming page is a live streaming channel page.

In some embodiments, the interaction method provided in the present disclosure may be implemented by the interaction apparatus provided in the present disclosure, wherein the interaction apparatus may be implemented in any software and/or hardware. In some embodiments, the interaction apparatus may be a tablet, a mobile phone (e.g., a foldable phone, a large screen phone, etc.), a wearable device, a vehicle-mounted device, an augmented reality (AR)/virtual reality (VR) device, a laptop, an ultra-mobile personal computer (UMPC), a netbook, a personal digital assistant (PDA), a smart television, a smart screen, a high-definition television, a 4K television, and other Internet of Things (IOT) devices, wherein the present disclosure does not impose any limitation on the specific type of the electronic device.

The present disclosure does not impose limitations on a type of an operating system of the electronic device. For example, the type of the operating system of the electronic device includes, but is not limited to, an Android system, a Linux system, a Windows system, an iOS system, and the like.

Based on the foregoing description, the embodiment of the present disclosure will, taking the electronic device as an example, and provide a detailed description of an interaction method provided in the present disclosure in conjunction with the accompanying drawings and application scenarios.

In the following embodiments, the description is made by taking an example that an electronic device is a mobile phone, and a mobile phone corresponding to a user 1 is installed with a client (hereinafter, referred to as a client 1), a mobile phone corresponding to a user 2 is installed with a client 2, and a mobile phone corresponding to a user 3 is installed with a client 3, wherein the user 1 is a viewer of a live streaming channel, the user 1 may enter the live streaming channel through the client 1 installed on the mobile phone, and send a resource and change a display mode of the resource, the user 2 is an anchor side publishing a live, and the user 3 is another viewer of the live streaming channel.

The client 1 corresponding to the user 1 may be understood as a first client, and the client 2 corresponding to the user 2 and the client 3 corresponding to the user 3 may be understood as a second client.

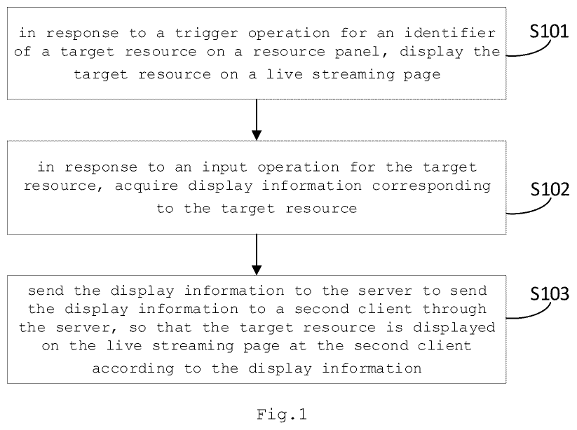

FIG. 1 is a schematic flow diagram of an interaction method according to some embodiments of the present disclosure. The mode of this embodiment is applied to the first client, and referring to FIG. 1, the method provided in this embodiment includes steps S101 to S103.

In step S101, in response to a trigger operation for an identifier of a target resource on a resource panel, the target resource is displayed on a live streaming page.

The resource panel may be configured to display a collection of identifiers of virtual resources. In some embodiments, the identifiers of the virtual resource displayed in the resource panel may include, but is not limited to: one or more of a video resource, an animation resource, etc. The animation resource includes, for example, an animation resource with a graphics interchange format (GIF).

The trigger operation for the identifier of the target resource on the resource panel may be, but is not limited to, a click operation, a voice operation, and the like for the identifier of the target resource.

In some embodiments, the user 1 starts the client 1 installed on the mobile phone and enters the live streaming channel that the user 1 desires to view, the client 1 may, on the live streaming page, provide a button 1 for entering the resource panel, the user 1 may enter the resource panel through the button 1 and select a virtual resource in the resource panel as the target resource, and the user 1 sends the target resource by clicking a display area corresponding to the target resource. After that, the client 1 may send information of the target resource to a server through the mobile phone, and the server may send the information of the target resource and data of the target resource to the users 2 and 3 to display the target resource in the respective live streaming pages of the users 2 and 3. The information of the target resource is display information of the target resource, and the data of the target resource is data of the target resource itself.

In step S102, in response to an input operation for the target resource, display information corresponding to the target resource is acquired.

In some embodiments, the display information may comprise: one or more of information of a display path, information of a display size, information of a display angle, or information of a display shape. That is, the user may control one or more of the display path, display size, display angle, or display shape of the target resource by means of the input operation.

It should be noted that the display information may be directed to a complete target resource, or a partial target resource (if the target resource includes two parts, the display information may be directed to one of them), which is not limited in this disclosure.

In some embodiments, in response to a setting request of the user, the first client provides a display setting panel, which receives an input operation of the user for the display setting panel to determine the display information corresponding to the target resource.

For example, the display setting panel may provide a display setting option or editing control, the user may input display information through the display setting option or editing control, and the first client receives the display information input by the user and takes the display information as the display information corresponding to the target resource.

For another example, the display setting panel may provide a plurality of display modes, and the user may select one of the plurality of display modes provided by the display setting panel as a target display mode. The first client determines, according to the target display mode selected by the user, display information corresponding to the target display mode as the display information corresponding to the target resource.

In some embodiments, the display setting panel may provide a plurality of labels, which correspond to display modes in different dimensions. For example, the display setting panel includes labels 1, 2, and 3, wherein the label 1 is configured to enter a display path setting panel which is configured to display a plurality of display paths; the label 2 is configured to enter a display size setting panel which can provide an option or editing control for setting a display size; the label 3 is configured to enter a display angle setting panel which can provide an option or editing control for setting a display angle. The user can switch the display modes in different dimensions by clicking the above labels 1 to 3, thereby setting the display mode of the target resource in the plurality of different dimensions through the setting panels corresponding to the dimensions.

In other embodiments, the user may input a touch operation for the target resource through a touch screen of the electronic device, and in response to the touch operation for the target resource, the display information directed to the target resource is acquired. Different touch operation types may be configured to control display modes of the target resource in different dimensions. For example, the touch operation may be a single-touch type or a multi-touch type. A touch operation of the single-touch type may be configured to control the display path of the target resource, and a touch operation of the multi-touch type may be configured to control the display size and/or the display angle of the target resource.

In step S103, the display information is sent to the server to send the display information to a second client through the server, so that the target resource is displayed on the live streaming page at the second client according to the display information.

In conjunction with the scenario exemplified in the foregoing step S101, based on the input operation of the user 1, the client 1 may send the display information directed to the target resource to the server through the mobile phone, and send the display information to the electronic device corresponding to the user 2 and the electronic device corresponding to the user 3 through the server.

For example, the user 1 selects a display path through the display setting panel on the live streaming page of the mobile phone, the mobile phone of the user 1 sends information of the display path to the server, and the server sends the information of the display path to the client corresponding to the user 2 and the client corresponding to the user 3, so that the target resource is, on the live streaming pages of the clients of the users 2 and 3, controlled to move according to the display path selected by the user 1. Therefore, in response to the user 1 sending the target resource and operating the display mode of the target resource, the users 2 and 3 can synchronously view the control of the user 1 for the display mode of the target resource.

In some embodiments, the client may further provide a corresponding permission switch, wherein in response to permission being closed, the resource is displayed in an original mode corresponding to the resource, and in response to the permission being opened, the resource may be displayed in a display mode set by the user sending the resource, and an operation of the user sending the resource for the resource is followed. Therefore, in response to the second client displaying the target resource, the state of the permission switch related to displaying the resource also needs to be combined. In some embodiments, the second client may display a first display mode identification and a second display mode identification. In response to a trigger operation of the user for the first display mode identification in the second client, the second client enables a first display mode, so that the target resource is displayed on the live streaming page at the second client according to the display information, the display information being the display information corresponding to the first client. In response to a trigger operation of the user for the second display mode identification in the second client, the second client disables the first display mode and enables the second display mode, so that the target resource is displayed on the live streaming page at the second client according to default information. The default information may be resource display information preset by the application. Therefore, this facilitates different users to select different display modes, so that flexibility of the display is improved, and user requirements are better met.

In some embodiments, in response to the trigger operation for the identifier of the target resource on the resource panel, the target resource is displayed on the live streaming page and guidance information corresponding to the target resource is displayed.

In some embodiments, the guidance information may be matched with a type of the target resource. In response to the type of the target resource being a first type, a first guidance information is displayed, which is guidance information corresponding to the first type; and in response to the type of the target resource being a second type, a second guidance information is displayed, which is guidance information corresponding to the second type.

In some embodiments, in the case where the target resource is a movement-type resource such as an airplane, a sports car, or the like, in response to the trigger operation for the identifier of the target resource on the resource panel, guidance information of a movement trajectory is displayed to guide the user to adjust the display mode of the target resource on the live streaming channel according to the movement trajectory. In the case where the target resource is a deformation-type resource such as a flower, in response to the trigger operation for the identifier of the target resource on the resource panel, deformation guidance information (for example, attempting to touch the flower to bloom by means of expansion of two fingers) is displayed to guide the user to adjust the display mode of the target resource on the live streaming channel according to the deformation information. Therefore, this further enriches the resource interaction mode, enhances the interaction atmosphere of the live streaming channel, and makes the display mode of the resource more matched with the resource to accord with the user expectation.

In response to the input operation for the target resource, the display information corresponding to the target resource is acquired. In some embodiments, it is also possible to pre-store, by the server, a correspondence between the display information and the input operation (such as a touch operation gesture), determine display information corresponding to a current input operation according to the correspondence, and send the display information to the client. For example, in response to a touch operation gesture being a leftward gesture, display information is leftward movement of the resource, and in response to a touch operation gesture is a rightward gesture, display information is rightward movement of the resource. Therefore, the display efficiency of the resource is improved.

In addition, in some embodiments, after sending the display information corresponding to the target resource to the second client (e.g., the anchor side) through the server, the first client sends a request message to the second client to request that the second client displays the target resource according to the display information corresponding to the target resource sent by the first client, and after agreeing to the request, the second client displays the target resource according to the display information on the live streaming page.

According to the method provided in this embodiment, after a user presents a target resource on a live streaming channel, a display mode of the target resource can be changed by means of an input operation, so that the user sending the target resource can participate in controlling the display mode of the target resource, helping to improve the enthusiasm of the user sending the target resource; in addition, other users (such as an anchor or other users) on the live streaming channel can also synchronously view that the target resource is displayed in the changed display mode, enriching the display mode of the target resource, and helping to improve the interactivity among different users on the live streaming channel.

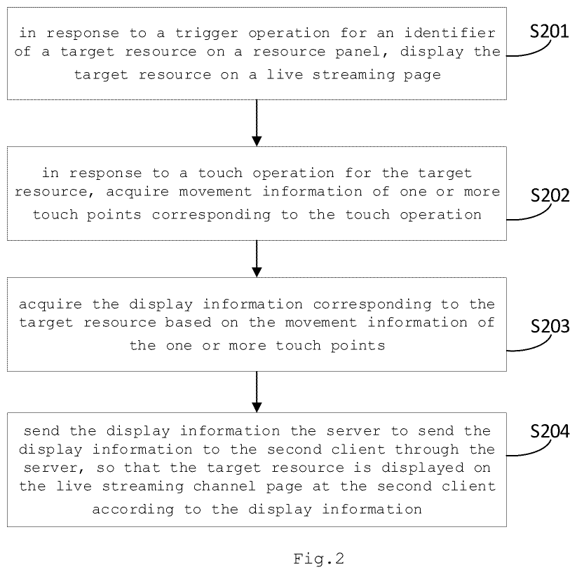

In some embodiments, the above input operation may include, but is not limited to, the touch operation. FIG. 2 is a schematic flow diagram of an interaction method according to other embodiments of the present disclosure. Referring to FIG. 2, the method of the present embodiment includes steps S201 to S204.

In step S201, in response to a trigger operation for an identifier of a target resource on a resource panel, the target resource is displayed on a live streaming page.

The step S201 in this embodiment is similar to the step S101 in the embodiment shown in FIG. 1, so that reference may be made to the detailed description of the embodiment shown in FIG. 1, which is not repeated here for brevity.

In conjunction with FIG. 1, the step S102 can be implemented by means of steps S202 to S203 in this embodiment.

In step S202, in response to a touch operation for the target resource, movement information of one or more touch points corresponding to the touch operation is acquired.

In conjunction with the foregoing description, the type of the touch operation may comprise: single-touch and multi-touch, and movement information of one or more touch points generated based on different types of touch operations also have a difference. For example, in response to the type of the touch operation being single-touch, the movement information of the one or more touch points may include movement information of a single touch point; and in response to the type of the touch operation being multi-touch, the movement information of the one or more touch points may include movement information corresponding to a plurality of touch points. And different types of touch operations can be configured to control display modes of the target resource in different dimensions.

In some embodiments, in response to a touch operation input by the user being received, it may be first determined whether the touch operation is single-touch or multi-touch, and then position information and time information corresponding to the position information of one or more touch points may be determined in a preset mode (e.g., periodically), thereby acquiring movement information of one or more touch points, that is, the movement information of the one or more touch points may comprise: position information and time information of the one or more touch points. The position information of the one or more touch points may be represented by coordinate values (x, y) of the one or more touch points in a two-dimensional coordinate system established based on the touch screen of the electronic device.

In some embodiments, it is assumed that determining that the type of the touch operation is single-touch, that is, the user touches the touch screen of the electronic device corresponding to the first client with a single finger (for example, a forefinger), at this time, first touch times and first touch positions (that is, position coordinates of the touch point in the touch screen of the electronic device corresponding to the first client) of a plurality of first touch points corresponding to the touch operation may be determined.

For example, the touch operation is a continuous action, a plurality of touch points may be determined continuously, which are generated sequentially in chronological order. In some embodiments, as shown in FIG. 3a, according to the single-touch operation of the forefinger of the user, 4 touch points, which comprise touch points a1 to a4, generated sequentially are determined,, wherein a time corresponding to the touch point a1 is t1, and a position corresponding to the touch point a1 is (x1, y1); a time corresponding to the touch point a2 is t2, and a position corresponding to the touch point a2 is (x2, y2); a time corresponding to the touch point a3 is t3, and a position corresponding to the touch point a3 is (x3, y3); and a time corresponding to the touch point a4 is t4, and a position corresponding to the touch point a4 is (x4, y4). Based on the continuous touch operation input by the user, position information and time information of more touch points can be determined, by taking the 4 touch points as an example for explanation here.

In some embodiments, it is assumed that determining that the type of the touch operation is multi-touch, that is, the user touches the touch screen of the electronic device corresponding to the first client with a plurality of fingers (e.g., two fingers comprising a thumb and a forefinger), at this time, information of touch points generated by the fingers is determined, such as determining second touch times and second touch positions (e.g., position coordinates of a plurality of second touch points generated by the thumb in the touch screen of the electronic device corresponding to the first client) of the touch points generated by the touch operation of the thumb, and third touch times and third touch positions (e.g., position coordinates of a plurality of third touch points generated by the forefinger in the touch screen of the electronic device corresponding to the first client) of the touch points generated by the touch operation of the forefinger.

For example, the touch operation is a continuous action, a plurality of touch points generated by the fingers can be continuously determined, which are arranged in chronological order. In some embodiments, as shown in FIG. 3b, according to the multi-touch operation of the thumb and the forefinger of the user, 8 touch points, which comprise touch points b1 to b4 and touch points c1 to c4, can be determined, wherein a time corresponding to the touch points b1 and c1 is t1, a position of the touch point b1 is (x1_{b}, y1_{b}), and a position of the touch point c1 is (x1_{c}, y1_{c}); a time corresponding to the touch points b2 and c2 is t2, a position of the touch point b2 is (x2_{b}, y2_{b}), and a position of the touch point c2 is (x2_{c}, y2_{c}); a time corresponding to the touch points b3 and c3 is t3, a position of the touch point b3 is (x3_{b}, y3_{b}), and a position of the touch point c3 is (x3_{c}, y3_{c}); and a time corresponding to the touch points b4 and c4 is t4, a position of the touch point b4 is (x4_{b}, y4_{b}), and a position of the touch point c4 is (x4_{c}, y4_{c}). Based on the continuous touch operation input by the user, position information and time information of more touch points can be determined, by taking the 8 touch points as an example for explanation here.

In step S203, the display information corresponding to the target resource is acquired based on the movement information of the one or more touch points.

How to obtain the display information of the target resource will be described below for the type of the touch operation being single-touch and multi-touch, respectively.

### 1. The Type of the Touch Operation is Single-Touch

In some embodiments, position information and sequence of discrete points in the display path in the display screen of the electronic device may be determined according to the movement information of the single touch point, thereby acquiring the information of the display path corresponding to the target resource.

In response to the positions of the sequentially generated first touch points being determined, normalized coordinate values can be used as the position information of the touch points, so that the positions of the discrete points in the display path are also in normalized representation, and the second client can calculate positions of the discrete points included in the display path in the display screen of the electronic device corresponding to the second client based on the normalized coordinate values, thereby suiting the accurate display of the target resource by the second client having the display screen in a different size.

In some embodiments, as shown in FIG. 3a, a connection line s1 from the touch point a1 to the touch point a4 is the display path of the target resource, wherein the touch points a1 to a4 correspond to 4 discrete points in the display path of the target resource, and positions corresponding to the touch points a1 to a4 are positions of the discrete points in the display path in the display screen of the electronic device.

In response to the positions of the sequentially generated first touch points being determined, normalized coordinate values can be used as the position information of the first touch points, so that the positions of the discrete points in the display path are also in normalized representation, and the second client can calculate the positions of the discrete points included in the display path in the display screen of the electronic device corresponding to the second client based on the normalized coordinate values, thereby suiting the accurate display of the target resource by the second client having the display screen in a different size.

### 2. The Type of the Touch Operation is Multi-Touch

In some embodiments, according to the movement information corresponding to the plurality of touch points, on the basis of chronological order of occurrence of the touch points, changes in distances and changes in rotation angles of connection lines between the plurality of touch points may be determined, and then the display size of the target resource may be determined based on the changes in the distances and the display angle of the target resource may be determined based on the changes in the rotation angles.

The display size and the display angle can be represented by means of a matrix, in which elements can represent positions of different key points of the target resource in the display screen of the electronic device. In addition, in order to suit the second client having the display screen in a different size, in response to the touch operation being multi-touch, values of the elements in the matrix can all be represented in a normalized mode.

In some embodiments, as shown in FIG. 3b, a connection line s2 from the touch point b1 to the touch point b4 is a movement trajectory of the thumb, and a connection line s3 from the touch point c1 to the touch point c4 is a movement trajectory of the forefinger. A dotted segment s4 exemplified in FIG. 3b is a connection line between the touch points b4 and c4, and a dotted segment s5 is a connection line between the touch points b3 and c3.

The display size of the target resource can be determined by comparing a difference between distances of the dotted segments s4 and s5, and in response to the length of the dotted segment s5 being greater than that of the dotted segment s4, it is indicated that zooming-in display of the target resource is needed, and in response to the length of the dotted segment s4 being greater than that of the dotted segment s5, it is indicated that zooming-out display of the target resource is needed. A specific scale of the zooming-in display or the zooming-out display can be determined according to the size of the difference.

The display angle of the target resource is determined by calculating an included angle (i.e., a rotation angle) between the dotted segments s4 and s5. In response to the included angle being 0, the display angle of the target resource does not need to be adjusted; and in response to the included angle being not equal to 0, it is indicated that the display angle of the target resource needs to be adjusted. The specific display angle can be determined according to the size of the included angle. In some embodiments, in response to the target resource having a three-dimensional structure, the display angle may be determined by combining the change in the distances between the dotted segments s4 and s5 and the size of the included angle.

How to determine the display angle is, in some embodiments, illustrated here by taking the touch points generated by the thumb and the forefinger respectively at times t1 and t2 as an example. As the thumb and the forefinger generate more and more touch points, a distance change and a rotation angle change of a connection line between a plurality of touch points recorded at a same time and a connection line between a plurality of touch points at a previous time are calculated in the similar mode as described above, thereby determining information of a new set of a display size and a display angle.

It should be noted that the above modes of determining the display size and the display angle are only examples, and they can be implemented in other modes.

In step S204, the display information is sent to the server to send the display information to the second client through the server, so that the target resource is displayed on the live streaming page at the second client according to the display information.

The step S204 in this embodiment is similar to the step S103 in the embodiment shown in FIG. 1, so that reference may be made to the detailed description of the embodiment shown in FIG. 1, which is not repeated here for brevity.

In addition, it should be noted that the touch operation input by the user may be implemented by means of a continuous action, and therefore, the determination of the position information and time information of the touch point, as well as the generation of the display information directed to the target resource, may be performed in parallel, and in response to the display information being generated, it is sent to the server in time to be sent to the second client, ensuring that the second client can follow the operation of the user in the first client for the target resource in time.

According to the method provided in this embodiment, after a user presents a target resource on a live streaming channel, a display mode of the target resource can be changed by means of a touch operation, so that the user sending the target resource can participate in controlling the display mode of the target resource, helping to improve the enthusiasm of the user sending the target resource; for the user, the input operation is in a simple and convenient mode, with good flexibility, so that the personalized requirements of the user can be met, and different types of touch operations can control display modes of the target resource in different dimensions, with more interestingness; in addition, other users (such as an anchor or other users) on the live streaming channel can also synchronously view that the target resource is displayed in the changed display mode, enriching the display mode of the target resource, and helping to improve the interactivity among different users on the live streaming channel.

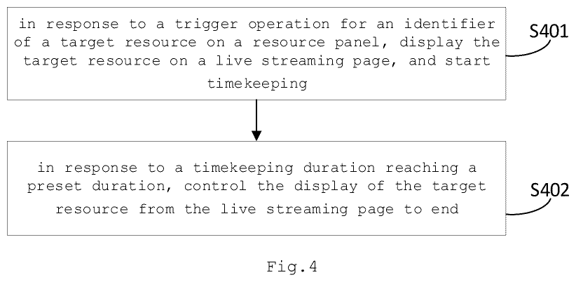

FIG. 4 is a schematic flow diagram of an interaction method according to other embodiments of the present disclosure. Referring to FIG. 4, the method of this embodiment includes steps S401 to S402.

In step S401, in response to a trigger operation on an identifier of a target resource on a resource panel, the target resource is displayed on a live streaming page, and timekeeping is started.

In response to a user sending the target resource on a live streaming channel through a first client, the first client can start a timer to start timekeeping.

In step S402, in response to a timekeeping duration reaching a preset duration, the display of the target resource from the live streaming page is controlled to end.

The preset duration may be understood as an effective display duration of the target resource. After timekeeping is started, the user can input an input operation for the target resource, and within the preset duration after the timekeeping is started, the input operation for the target resource that is input by the user can be regarded as an effective operation. The preset duration is not limited in the present disclosure, and can be set as needed, such as 10 seconds, 15 seconds, and the like.

In addition, the first client sends information of the target resource to a server, and send the information of the target resource to a second client through the server, and in response to the second client displaying the target resource on the live streaming page, a timer is started and timekeeping is started. In response to a timekeeping duration of the second client reaching the preset duration, the second client controls the display of the target resource to end.

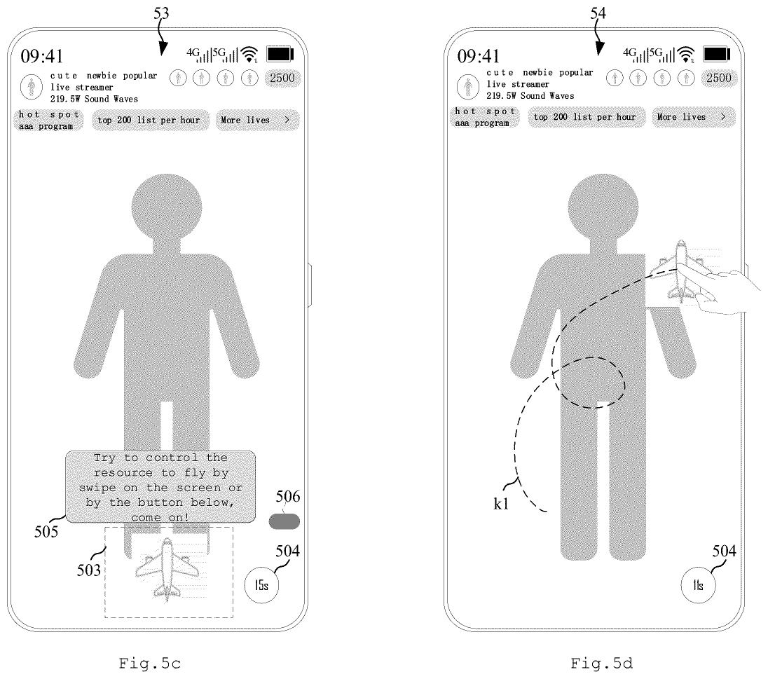

Embodiments shown in FIGS. 5a to 5f are schematic diagrams of human-computer interaction interfaces provided in the present disclosure. In the embodiments shown in FIGS. 5a to 5f, an example that a user 1 is a viewer viewing a live and a user 2 is an anchor publishing the live is taken for explanation. An electronic device (e.g., a mobile phone) used by the user 1 is installed with a client 1. FIGS. 5a to 5f are schematic diagrams of user interfaces displayed by the client 1 corresponding to the user 1.

Referring to FIG. 5a, after the user 1 starts the client 1 and enters a live streaming channel he desires to view, the client 1 exemplarily displays the user interface 51 as shown in FIG. 5a on the mobile phone. The user interface 51 shown in FIG. 5a is mainly configured to display a live streaming page viewed by the user 1, live content displayed on the live streaming page being multimedia content published by the user 2.

The user interface 51 may also include a button 501 for entering a resource panel.

The client 1 receives a trigger operation of the user 1 on the button 501, and the client 1 may exemplarily display the user interface 52 as shown in FIG. 5b on the mobile phone.

Referring to FIG. 5b, the user interface 52 comprises: an area 502, the area 502 being configured to display the resource panel, and the resource panel being configured to display a collection of identifiers of resources, so that the user can select a resource from the collection of resources according to the collection of identifiers of resources displayed on the resource panel and send it to the live streaming channel.

Assuming that the user 1 selects an airplane resource in a first row and a first column in the area 502 as the target resource, the user 1 clicks a send button corresponding to the airplane resource to send the airplane resource to the live streaming channel. The client 1 exemplarily displays a user interface 53 shown in FIG. 5c on the mobile phone. For example, the airplane resource is an airplane gift.

The user interface 53 includes: an area 503, which is configured to display the airplane resource that the user 1 selects to send. A size, position, etc. of the area 503 are not limited in the present disclosure.

In response to the display of the target resource being started, the client 1 may start timekeeping, e.g., a timer is displayed in an area 504 of the user interface 53, and starts timekeeping.

In addition, prompt information may also be displayed in the user interface 53 to prompt that the user can input a touch operation for the target resource to control a display mode of the target resource, such as a display path, a display size, a display angle, and the like. Exemplarily, referring to FIG. 5c, the user interface 53 further includes: an area 505, which is configured to display a prompt message in a text mode. Text content is, for example: “Try to control the resource to fly by swipe on the screen or by the button below, come on!”, and of course, the text content may also be other content, and is not limited to the example of FIG. 5c.

In some embodiments, the client 1 receives the touch operation input by the user 1 on the screen of the mobile phone, it is possible to determine, in the above mode of the embodiment shown in FIG. 2, that it is single-touch or multi-touch, and generate display information based on movement information of one or more touch points.

For example, as shown in a user interface 54 in FIG. 5d, the client 1 receives the touch operation input by the user 1, wherein k1 in FIG. 5d is a trajectory connected by a plurality of touch points determined by the client 1, the target resource moving along the trajectory shown by k1 from an initial position. That is, k1 is a display path of the target resource.

For example, as shown in a user interface 55 in FIG. 5e, the client 1 receives a multi-touch operation input by the user 1, wherein k2 and k3 are trajectories connected by touch points respectively generated by two fingers of the user 1 touching a screen of the mobile phone, and a display size and display angle of the target resource are changed according to changes in distances and rotation angles of the above k2 and k3. FIG. 5e illustrates a case where the target resource is rotated 180 degrees and the display size is zoomed out. It should be noted that in response to a display path of the resource being not set by the user, the resource may move according to a preset path, for example, a path shown by k4 in FIG. 5e is a preset path corresponding to the airplane, wherein the display angle and the display size of the airplane are changed continuously during the movement of the airplane along the path shown by k4.

Referring to FIG. 5c, the client 1 may, in the user interface 53, further display a button 506 which is configured to enter into a display setting panel, the client 1 receives a trigger operation (e.g., a click operation) of the user 1 for the button 506, the client 1 displays a user interface 56 as shown in FIG. 5f on the mobile phone, the user interface 56 including: an area 507, the area 507 being configured to display the display setting panel through which the user can set the display path, the display size, the display angle, and the like.

In some embodiments, the area 507 further includes: labels 507a, 507b, and 507c. The label 507a is configured to display a display path setting panel in the area 507, wherein the display path setting panel is configured to display a variety of display paths for selection by the user. The label 507b is configured to display a display size setting panel in the area 507, wherein the display size setting panel may provide a display size editing option. The label 507c is configured to display a display angle setting panel in the area 507, wherein the display angle setting panel may provide a display angle editing option. In addition, the method further comprises, in response to a preview operation of the user for the target display mode (which can be, for example, any candidate display path in a plurality of candidate display paths), displaying resource preview information corresponding to the target display mode, facilitating the user to adjust the display mode according to the preview information in time.

In some embodiments, it is possible not to arrange the labels corresponding to the display setting panels in different dimensions, but to list selectable display modes in the area 507, and add identifications corresponding to the selectable display modes, enabling the user to clearly understand details of each display mode.

After the user 1 selects and confirms a display mode through the display setting panel or generates the display information directed to the target resource by means of the touch operation, the client 1 can send the display information to the server, the server sends the display information to a client corresponding to the user 2, and the client corresponding to the user 2 displays the target resource on the live streaming page according to the received display information. The client corresponding to the user 2 displays the display mode of the target resource on the live streaming page according to the received display information.

It should be noted that, after the user 1 selects sending the resource by means of the send button shown in FIG. 5b, the client 1 corresponding to the user 1 and the client corresponding to the user 2 may perform display in a preset display mode corresponding to the resource, and in response to the user 1 performing an input operation for the resource, the client corresponding to the user 1 and the client corresponding to the user 2 may synchronously respond to the input operation of the user 1 for the resource. In some embodiments, referring to FIG. 5f, in response to the user 1 not selecting to confirm one or more of the display path, the display size, or the display angle, the airplane resource moves along the path k4.

It should be noted that the above paths k1 to k4 are configured to assist in explaining the movement trajectory of the resource and the trajectory of the user operation, and may not be displayed in the live streaming page.

In some embodiments, in response to selecting the target resource, but before not sending the target resource to the live streaming channel, the user 1 may also set the display mode of the target resource through the display setting panel, and after determining the display mode of the target resource, send the target resource to the live streaming channel, so that the target resource is displayed on the live streaming page in the mode set by the user.

It should be noted that the present disclosure is not limited to implementing the control of the user in the display mode of the target resource in the mode provided in the embodiments shown in FIGS. 5a to 5f, and may also implement the control in other modes, which is not limited in the present disclosure.

In some embodiments, the present disclosure also provides an interaction apparatus.

FIG. 6 is a schematic structural diagram of a live interaction apparatus according to some embodiments of the present disclosure. Referring to FIG. 6, the live interaction apparatus 600 provided in this embodiment comprises:
a display module 601 configured to, in response to a trigger operation for an identifier of a target resource on a resource panel, display the target resource on a live streaming page;
a processing module 602 configured to, in response to an input operation for the target resource, acquire display information corresponding to the target resource;
a communication module 603 configured to, send the display information to a server to send the display information to a second client through the server, so that the target resource is displayed on the live streaming page at the second client according to the display information.

In some embodiments, the input operation comprises a touch operation; and the processing module 602 is specifically configured to: in response to the touch operation for the target resource, acquire movement information of one or more touch points corresponding to the touch operation; and acquire the display information corresponding to the target resource based on the movement information of the one or more touch points.

In some embodiments, in response to a type of the touch operation being single-touch, the movement information of the one or more touch points comprises movement information of a single touch point; and the processing module 602 is specifically configured to: acquire information of a display path corresponding to the target resource according to the movement information of the single touch point, the display information comprising the information of the display path.

In some embodiments, in response to a type of the touch operation being multi-touch, the movement information of the one or more touch points comprises movement information corresponding to a plurality of touch points; and the processing module 602 is specifically configured to: acquire information of a display size and/or a display angle corresponding to the target resource according to the movement information corresponding to the plurality of touch points, the display information comprising the information of the display size and/or the display angle.

In some embodiments, in response to the display information comprises the information of the display size; the processing module 602 is specifically configured to: determine distances between the plurality of touch points according to the movement information corresponding to the plurality of touch points; and determine the information of the display size corresponding to the target resource according to the distances between the plurality of touch points.

In some embodiments, in response to the display information comprising the information of the display angle; the processing module 602 is specifically configured to: determine rotation angles of connection lines between the plurality of touch points according to the movement information corresponding to the plurality of touch points; and acquire the information of the display angle corresponding to the target resource according to the rotation angles of the connection lines between the plurality of touch points.

In some embodiments, the processing module 602 is specifically configured to: in response to an input operation for a target display mode in a display setting panel corresponding to the target resource, acquire display information corresponding to the target display mode as the display information corresponding to the target resource, the target display mode comprising: one or more of a display path, a display size, or a display angle.

In some embodiments, the processing module 602 is further configured to: in response to the target resource being displayed on the live streaming page, start timekeeping; and in response to a timekeeping duration being greater than a preset duration, control the display of the target resource from the live streaming page to end.

The apparatus provided in this embodiment may be configured to execute the technical solution of the first client in any of the method embodiments described above, and has similar implementation principles and technical effects, so that reference may be made to the detailed description of the method embodiments described above, which is not repeated here for brevity.

In some embodiments, an embodiment of the present disclosure also provides an electronic device.

FIG. 7 is a schematic structural diagram of an electronic device according to some embodiments of the present disclosure. Referring to FIG. 7, the electronic device 700 provided in this embodiment comprises: a memory 701 and a processor 702.

The memory 701 may be a separate physical unit that is connected with the processor 702 via a bus 703. The memory 701 and the processor 702 may also be integrated together, which is implemented by hardware, etc.

The memory 701 is configured to store program instructions, and the processor 702 calls the program instructions to execute the interaction method according to any of the above method embodiments.

In some embodiments, when part or all of the method of the above embodiments is implemented by software, the above electronic device 700 may also include only the processor 702. The memory 701 for storing a program is located outside the electronic device 700 and the processor 702 is connected with the memory via a circuit/wire for reading and executing the program stored in the memory.

The processor 702 may be a central processing unit (CPU), a network processor (NP), or a combination of the CPU and NP.

The processor 702 may further include a hardware chip. The above hardware chip may be an application-specific integrated circuit (ASIC), a programmable logic device (PLD), or a combination thereof. The above PLD may be a complex programmable logic device (CPLD), a field-programmable gate array (FPGA), a general array logic (GAL), or any combination thereof.

The memory 701 may include a volatile memory, such as a random-access memory (RAM); the memory may also include a non-volatile memory (non-volatile memory), such as a flash memory, a hard disk drive (HDD) or a solid-state drive (SSD); and the memory may also include a combination of the above kinds of memories.

The present disclosure also provides a non-transitory readable storage medium, comprising: computer program instructions which, when executed by at least one processor of an electronic device, cause the electronic device to implement the interaction method according to any of the method embodiments above.

The present disclosure also provides a computer program product which, when run on a computer, causes the computer to implement the interaction method according to any of the method embodiments above.

The present disclosure also provides a computer program, comprising: instructions which, when executed by a processor, cause the processor to perform the interaction method according to any of the method embodiments above.

It should be noted that, relational terms such as “first” and “second”, herein, are only used for distinguishing one entity or operation from another entity or operation without necessarily requiring or implying any such actual relation or order between these entities or operations. Moreover, the term “comprise”, “include”, or any other variation thereof, is intended to encompass a non-exclusive inclusion, such that a process, method, article, or device comprising a list of elements not only includes those elements but also includes other elements not expressly listed, or also includes elements inherent to such a process, method, article, or device. Without more limitations, an element defined by a statement “comprising a . . . ” does not exclude the presence of another identical element in a process, method, article, or device that includes the element.

The above only describes the specific implementations of the present disclosure, which enable those skilled in the art to understand or implement the present disclosure. Various modifications to these embodiments will be apparent to those skilled in the art, and the general principles defined herein may be implemented in other embodiments without departing from the spirit or scope of the present disclosure. Therefore, the present disclosure will not be limited to these embodiments described herein, but conform to the widest scope consistent with the principles and novel features disclosed herein.

1. An interaction method, applied to a first client, comprising:
in response to a trigger operation for an identifier of a target resource on a resource panel, displaying the target resource on a live streaming page;
in response to an input operation for the target resource, acquiring display information corresponding to the target resource; and
sending the display information to a server to send the display information to a second client through the server, so that the target resource is displayed on the live streaming page at the second client according to the display information.

2. The interaction method according to claim 1, wherein the input operation comprises a touch operation, and
the in response to an input operation for the target resource, acquiring display information corresponding to the target resource, comprises:
in response to the touch operation for the target resource, acquiring movement information of one or more touch points corresponding to the touch operation; and
acquiring the display information corresponding to the target resource based on the movement information of the one or more touch points.

3. The interaction method according to claim 2, wherein:
in response to a type of the touch operation being single-touch, the movement information of the one or more touch points comprises movement information of a single touch point; and
the acquiring the display information corresponding to the target resource based on the movement information of the one or more touch points, comprises:
acquiring information of a display path corresponding to the target resource according to the movement information of the single touch point, the display information comprising the information of the display path.

4. The interaction method according to claim 2, wherein:
in response to a type of the touch operation being multi-touch, the movement information of the one or more touch points comprises movement information corresponding to each of a plurality of touch points; and
the acquiring the display information corresponding to the target resource based on the movement information of the one or more touch points, comprises:
acquiring information of a display size and/or a display angle corresponding to the target resource according to the movement information corresponding to each of the plurality of the one or more touch points, the display information comprising the information of the display size and/or the display angle.

5. The interaction method according to claim 4, wherein in response to the display information comprising the information of the display size, the acquiring information of a display size and/or a display angle corresponding to the target resource according to the movement information corresponding to each of the plurality of touch points, comprises:
determining distances between the plurality of touch points according to the movement information corresponding to each of the plurality of touch points; and
determining the information of the display size corresponding to the target resource according to the distances between the plurality of touch points.

6. The interaction method according to claim 4, wherein in response to the display information comprising the information of the display angle, the acquiring information of a display size and/or a display angle corresponding to the target resource according to the movement information corresponding to each of the plurality of touch points, comprises:
determining rotation angles of connection lines between the plurality of touch points according to the movement information corresponding to each of the plurality of touch points; and
acquiring the information of the display angle corresponding to the target resource according to the rotation angles of the connection lines between the plurality of touch points.

7. The interaction method according to claim 2, wherein the movement information of the one or more touch points comprises position information and time information of each touch point.

8. The interaction method according to claim 1, wherein the in response to an input operation for the target resource, acquiring display information corresponding to the target resource, comprises:
in response to an input operation for a target display mode in a display setting panel corresponding to the target resource, acquiring display information corresponding to the target display mode as the display information corresponding to the target resource.

9. The interaction method according to claim 8, wherein the target display mode comprises: one or more of a display path, a display size, or a display angle.

10. The interaction method according to claim 1, wherein the in response to an input operation for the target resource, acquiring display information corresponding to the target resource, comprises:
receiving display information input by a user by means of a display setting option or editing control provided by a display setting panel corresponding to the target resource, as the display information corresponding to the target resource.

11. The interaction method according to claim 1, further comprising:
in response to the display of the target resource being started live streaming page, starting timekeeping; and
in response to a timekeeping duration being greater than a preset duration, controlling the display of the target resource from the live streaming page to end.

12. The interaction method according to claim 1, wherein: the input operation comprises a touch operation; and different touch operation types are configured to control display modes of the target resource in different dimensions.

13. The interaction method according to claim 1, further comprising: in response to the trigger operation for the identifier of the target resource on the resource panel, displaying guidance information corresponding to the target resource.

14. The interaction method according to claim 1, wherein the sending the display information to a server to send the display information to a second client through the server, so that the target resource is displayed on the live streaming page at the second client according to the display information, comprises:
sending the display information to the server to send the display information to the second client through the server, so that the second client displays the target resource on the live streaming page according to the display information, in response to a first display mode being disabled and a second display mode being enabled.

15. A interaction apparatus, applied to a first client, comprising:
a display module configured to, in response to a trigger operation for an identifier of a target resource on a resource panel, display the target resource on a live streaming page;
a processing module configured to, in response to an input operation for the target resource, acquire display information corresponding to the target resource; and
a communication module configured to send the display information to a server to send the display information to a second client through the server, so that the target resource is displayed on the live streaming page at the second client according to the display information.

16. A non-transitory computer-readable storage medium, comprising: computer program instructions which, when executed by a processor of an electronic device, cause the electronic device to implement the interaction method, comprising:
in response to a trigger operation for an identifier of a target resource on a resource panel, displaying the target resource on a live streaming page;
in response to an input operation for the target resource, acquiring display information corresponding to the target resource; and
sending the display information to a server to send the display information to a second client through the server, so that the target resource is displayed on the live streaming page at the second client according to the display information.

17. An electronic device, comprising: a memory and a processor,
the memory being configured to store computer program instructions; and
the processor being configured to execute the computer program instructions to implement the interaction method according to claim 1.

18-19. (canceled)

20. The non-transitory computer-readable storage medium according to claim 16, wherein:
the input operation comprises a touch operation; and
the in response to an input operation for the target resource, acquiring display information corresponding to the target resource, comprises:
in response to the touch operation for the target resource, acquiring movement information of one or more touch points corresponding to the touch operation; and
acquiring the display information corresponding to the target resource based on the movement information of the one or more touch points.

21. The non-transitory computer-readable storage medium according to claim 20, wherein:
in response to a type of the touch operation being single-touch, the movement information of the one or more touch points comprises movement information of a single touch point; and
the acquiring the display information corresponding to the target resource based on the movement information of the one or more touch points, comprises:
acquiring information of a display path corresponding to the target resource according to the movement information of the single touch point, the display information comprising the information of the display path.

22. The non-transitory computer-readable storage medium according to claim 20, wherein:
in response to a type of the touch operation being multi-touch, the movement information of the one or more touch points comprises movement information corresponding to each of a plurality of touch points; and
the acquiring the display information corresponding to the target resource based on the movement information of the one or more touch points, comprises:
acquiring information of a display size and/or a display angle corresponding to the target resource according to the movement information corresponding to each of the plurality of the one or more touch points, the display information comprising the information of the display size and/or the display angle.
